(19) United States
(12) Patent Application Publication
(10) Pub. No.: US 2012/0167747 A1
(43) Pub. Date: Jul. 5, 2012

(54) Method and Device for Playing of Musical Melodies

(76) Inventor: Alexander Luchinskiy, Bad Kreuznach (DE)

(21) Appl. No.: 13/346,949

(22) Filed: Jan. 10, 2012

Related U.S. Application Data
(60) Provisional application No. 61/432,854, filed on Jan. 14, 2011.

(30) Foreign Application Priority Data
Jan. 15, 2010 (DE) DE102010004812.7
Jan. 19, 2010 (DE) DE102010005144.6
Jul. 18, 2010 (DE) DE102010027549.2
Sep. 23, 2010 (DE) DE 102010046184.9

(51) Int. Cl. G09B 15/06

(52) U.S. Cl. 84/485 R

(57) ABSTRACT

Method and device for playing of musical melodies and for learning to play musical melodies, which comprises the shining/lighting indicators, which are placed under-, on-, in-, or near the keys of an electronic piano, system for switching-on and switching-off of these shining/lighting indicators, means for controlling of this a.m. switching-on&off system, the shining/lighting indicators for placing on the human fingers, which indicators are provided with the means for their fastening on the human fingers, wherein these shining/lighting indicators are electrically connected to the system for switching-on&off of these shining/lighting indicators, and thereby are these shining/lighting indicators also connected with the means for controlling of this a.m. switching-on&off system.

### CROSS-REFERENCE TO RELATED APPLICATIONS

This application claims the priority benefits to US provisional patent application, Ser. No. 61/432,854 filed Jan. 14, 2011, to German Patent Application DE 10 2010 046 184.9, filed Sep. 23, 2010, to German Patent Application DE 10 2010 027 549.2, filed Jul. 18, 2010, to German Patent Application DE 10 2010 005 144.6, filed Jan. 19, 2010, to German Patent Application DE 10 2010 004 812.7, filed Jan. 15, 2010.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISC APPENDIX

Not Applicable

### BACKGROUND OF THE INVENTION

(1) Field of the Invention

The present invention relates to methods to perform music and musical instruments.

(2) Description of Related Art

The method is generally known, which is named Karaoke. The method provides the performance of songs by the human voice in the correspondence with bars (i.e. time measures in music).

Method comprises a representation of a text of a song on the screen, wherein the script lines or the phrases are presented in the order sequencely on the screen in a text form, and wherein the separate syllables or words in these lines (phrases) are indicated in the order by a marker on the screen.

Wherein one moves the marker along this script such way, that every syllable (or word) is marked exactly in the time moment, when this syllable (or this word) must be sung. One can use colours, signs etc. as a marker, i.e. the syllables (words) can shine temporarily in the order, or change their colour, or change their dimensions, or be underlined sequencely in order, etc.

Simultaneously a music sounds, which one accompanies normally this song.

The main aim and main value of this method (Karaoke) is that every amateur, among others also a person, who does not have any musical education at all, who does not know musical notes, and who even does not have any ear for music, can sing correctly or almost correctly a real song by the own voice a) himself independently and b) immediately, without preparation and training. And this way he can get a pleasure or he can generate a definite attitude of mind for himself. This aim is attained such way, that one can perform a musical work of art actively and himself independently.

In the case of an ordinary hearing of a song a person is in a passive role. Therewith the active reproducing of a song is a main characteristic feature of the karaoke.

In addition, this method also has a teaching function, because one can perform better the each repeating of the song, and finally, after the multiple self-executed repeating of the song, one could sing correctly or almost correctly even without the marked syllables.

There is no analogous method in a musical instrumental area presently. I.e. there is no method, by which any amateur could play piano, electronic piano (keyboard), and other musical instruments himself independently and without instruction or without previous preparation.

Under the term “amateur” a person is meant, who has no musical education, among others does not know the musical notes, and possibly also does not have an ear for music.

Therewith presently an amateur cannot perform an active music playing by musical instruments without a previous basic instruction, but he can only hear passively a music, which is played by other people.

A generally known method of teaching to play piano is also known, wherein one used the lighting piano keys. One use for it an electronic piano (normally named as “keyboard” or “piano-keyboard”), which piano is provided with the shining/lighting indicators, which are placed under the piano keys.

The teaching to play melody has 3 stages and it is executed only for one hand (the right one or the left one on the own choice). During the stage 1 the keys are shining (igniting) in succession, according to the melody, and the learning person press these keys in succession by one his finger. By doing so the mistakenly pressings of keys are “excused”, i.e. the each next key is switched on and shines in any case, also when the previous key was pressed wrong way. During the stage 2 the learning person learns the true succession of the keys, i.e. the each next key will be switched on and will shine only after the taken place correct pressing of the previous key.

Wherein during the stage 2, the same way as during the stage 1, the learning person press the keys in succession by one of his fingers. During the stage 3 the learning person learns to play true way, i.e. with the definite finger. It is realised such way that an electronic piano-keyboard is provided with the keys, which can shine with one of two colours—red and yellow, as well, self-evidently, this keyboard is provided with the correspondent control equipment. A. red-shining source of light is switched on under the key, which have to be pressed by the correct finger, and three yellow-shining light sources are switched on under the three keys, above which the three middle fingers (forefinger, middle finger and ring finger) have to be positioned.

In one other embodiment, a hand is graphically schematically shown in a display, and a true finger, by which one must play in the moment, is graphically marked in this display picture.

And in one other embodiment the true finger, by which one must play in the moment, is named automatically by human voice as a number (from 1 to 5).

The above-mentioned method, as well the devices for the realisation of this method, have the following shortcomings:

Shortcoming (1):

This method of training is not an analogy of the karaoke, because this method does not provide an immediate not-prepared playing of music by a amateur without learning.

Here is the reason for it:

From the moment of light ignition under a key, until the moment when one press by one correctly defined finger on this key, there is a chain of tasks, which have to be solved by the human brain, and this chain of tasks have to be solved always once again for each next key. In this above mentioned method this chain is too long for the immediate music playing. (s. detailed in the subitems 1.1-1.3 below).

Without preliminary trainings one cannot solve quickly this long chain of tasks, and therewith to play music immediately without preparations. Therefore either one need a fundamental preliminary training for the every definite melody playing, or this chain of tasks have to be shorted through some other technical solution.

Shortcoming (2):

The known a.m. method and the devices for its embodiment do not make possible there use as a mass market product, because the technical embodiments of this method are too complicated and therefore too expensive. In the frames of the known concepts, as well in the frames of the known embodiments of this method, the design (construction) of these embodiments cannot be radically simplified, because in the frames of the known concept these embodiments must include the complicated elements for the realisation of the method (s. subitem 2.1 below). Therefore the product expenses cannot be reduced essentially.

More detailed:

Concerning item (1):

In the known a.m. devices (embodiments), before one press on a correct key by a correct finger, the brain have to solve the following, below under the positions a), b), c), etc. mentioned tasks, wherein these tasks have to be solved once again separately for the each next key. The items 1.1-1.3 differentiate the different embodiments with the different equipment for indication of a true finger:

1.1) The tasks for the execution by brain&body if the finger indication takes place by a voice. (Electronic piano-keyboard says with human voice, by what finger in this moment one have to press the lighting key):

a) to recognise the number, which was said as a word by a voice; b) to recognise/determine the finger on the own hand, which finger corresponds to this number; c) to recognise/determine the lighting key; d) to press on this key by this previously analytically recognised/found out finger.

1.2) The tasks for the execution by brain&body if the finger indication takes place by a display. (The graphical schemata of hands are presented on the display by an electronic piano. The user have to choose only one of these two hand schemes, either right hand, or left hand. Electronic keyboard indicates on the display graphically, by what finger the shining key in the moment have to be pressed):

a) to recognise the hand, which is presented as a scheme on display, and to recognise which finger is indicated in the moment in this hand schema; b) to recognise/determine the finger on the own hand, which finger corresponds to the finger, which is indicated in this graphical schema; c) to recognise/determine the shining key; d) to press on this key by this previously analytically recognised/found out finger.

1.3) The tasks for the execution by brain&body if the finger indication takes place by the additional shining keys:

a) to recognise three yellow-shining keys; b) to position the three middle fingers (forefinger, middle finger and ring finger) exactly above these keys; c) to recognise/determine a red-shining key; d) to find out, which from 5 fingers stays exactly above the red-shining key; c) to press on this red-shining key by this previously analytically recognised/found out finger.

Human brain must solve anew the above mentioned tasks for the each next pressing of a key. The tasks (a) and (b) in the items (1.1) and (1.2), and die tasks (a), (b) and (d) in the item (1.3) are conceptually unnecessary. One need these interim solutions neither for an immediate direct music playing, nor for a learning to play piano for the future. These interim operations belong only to the above mentioned known method embodiments, and one need these operations only for the realisation of the mentioned known method by means of the known devices.

Besides, one have to determine analytically the true finger (task (b) in the items (1) and (2) or task (d) in the item (3)), which operation takes a lot of time and attention for the every pressing of a key. Although one could use a direct indication.

Besides, the known method provides the shining keys—managed playing with one hand only, i.e. with the right or with the left hand on user's choice. The chain of tasks, which in this case have to be realised by a human brain during a short time, is too large and complicated. Therefore in any case, in the frames of the known method, an amateur cannot play immediately a real musical work of art, as it takes place by the realization of a karaoke method.

Concerning item (2):

2.1) The known devices contain the complicated and expensive elements (as for example, microchips and other electronic and electrical elements for the signal analysis and controlling, electrical amplifier, display, loudspeaker, etc., which functions and tasks could be taken over by an usual PC with its peripherals. If somebody, who want to play music himself or who want to learn to play music, own already a PC with peripherals, he does not need to bye the complicated and therefore expensive devices.

### BRIEF SUMMARY OF THE INVENTION

The object of the method of the presently claimed invention is to provide a technical possibility for everybody to play an electronic piano (piano-keyboard) and other musical instruments independently and without learning or previous preparations.

The attained by the invention advantages are that the possibility is provided of a not-prepared immediate musical-instrumental playing of a real musical composition by an amateur, i.e. by a person,

who has no musical education, who among others does not know the musical notes, and who possibly also does not have an ear for music. And therewith the musical-instrumental analogy of karaoke is provided.

The aim of invention is attained as follows:

1) the shining/lighting indicators are placed also on the fingers, but not only under the keys. (In the description below the placed under (or on-, or in-, or near-) the keys (buttons) of a musical instrument shining/lighting indicators are named as “key-lights”, and the placed on the fingers shining/lighting indicators are named as “finger-lights”.) A key-light under the key, which have to be pressed in the moment, and a finger-light on the true finger, by which one have to press this a.m. key, are switched on simultaneously. Therewith a human brain does not get any superfluous information, but only a useful information, and concretely—that in this moment of time one have to press a shining key by a shining finger; or to put the two lights together. A human brain solves this task in several times quicker then the chain of the analytical tasks, which are realised in the known methods&devices, and which are described in the mentioned above items (1.1)-(1.3). One need this a.m. useful information also for the learning aims, i.e. for the aim to play this musical composition better in the future or for the aim to play it later by a traditional musical instrument without the light-keys. The superfluous information, which is described above in the items (1.1)-(1.3), and which belong to the special technical features of the known method&devices only, is cancelled.

Besides, as the tasks for brain are therewith essentially simplified, one can now indicate on the both hands jointly the necessary in a moment for a play fingers (with the correspondent keys together), what is necessary for any playing of a real musical composition. Additionally one can also indicate by a light several fingers on the each of hand simultaneously (with the correspondent keys together), if a musical composition requires a simultaneous playing of several notes.

2) All control functions, as well as also the functions of processing of signals and playing of music are realised not by an electronic piano, but by an usual PC and its peripherals, which one (PC and its peripherals) are already owned by a majority of users. An electronic piano-keyboard must not contain the electronic microchips, any equipment for the electronic processing of information, memory devices, display, amplifier, loudspeaker, and any other devices, which functions can be executed by a PC and its peripherals.

Wherein the all necessary data and software are placed by a producer in a website or in a data carrier (CD, DVD or others), and after that the necessary for playing of music data and, by necessity also a software, is downloaded by a final client (user) from this a.m. website or from this a.m. data carrier.

### BRIEF DESCRIPTION OF THE SEVERAL VIEWS OF THE DRAWINGS

The examples of the embodiments of the invention are presented schematically in the drawings and are described below.

It is shown:

FIG. 1 shows schematically the possible configurations of the necessary elements.

FIG. 2 shows schematically the possible fastenings of the finger-lights directly on the fingers.

FIG. 3 shows schematically the possible fastening of the finger-lights on a glow.

### DETAILED DESCRIPTION OF THE INVENTION

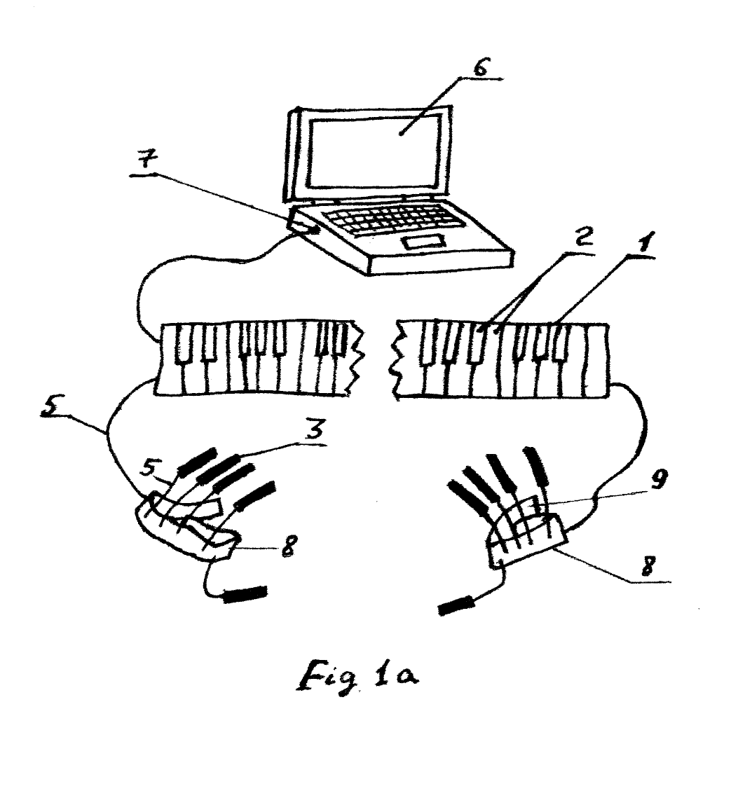

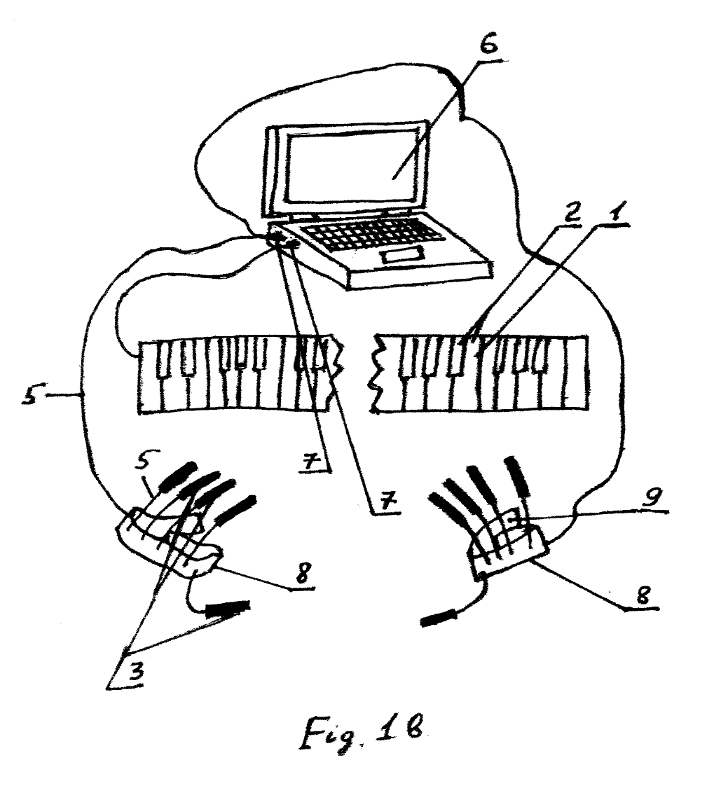

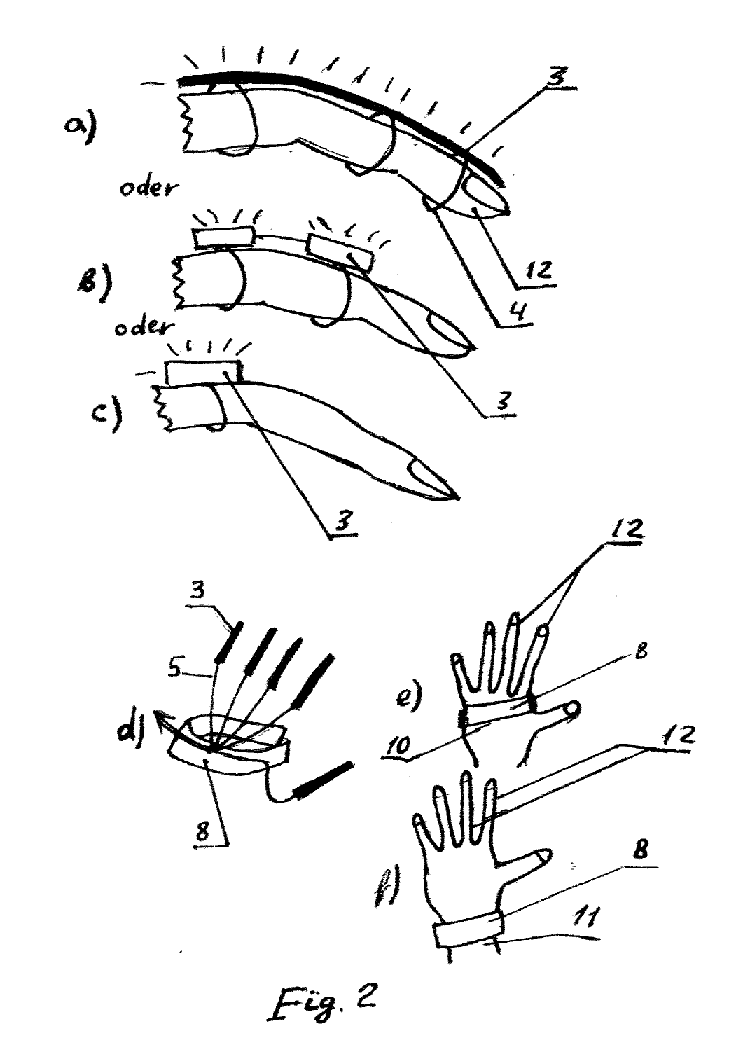

A keyboard 1 with the key-lights 2 is connected to a PC 6 (FIG. 1). The finger-lights 3 are fastened on the fingers 12 by the ring-like rubber-like fastening 4 (FIG. 2). The finger-lights 3 are connected by the electrical lines (wires) 5 with a computer (PC) 6 directly (FIG. 1.b) or through a keyboard 1 (FIG. 1.a) (for example, through an USB-port 7). The electrical lines (wires) 5 from the finger-lights 3 are fastened mechanically on the left and right hands by the fastening belt 8 (among others by a Velcro-fastening 9). The fastening belt 8 can be fastened, among other places, on a palm 10 (FIG. 2e) or on a wrist 11 (FIG. 2f).

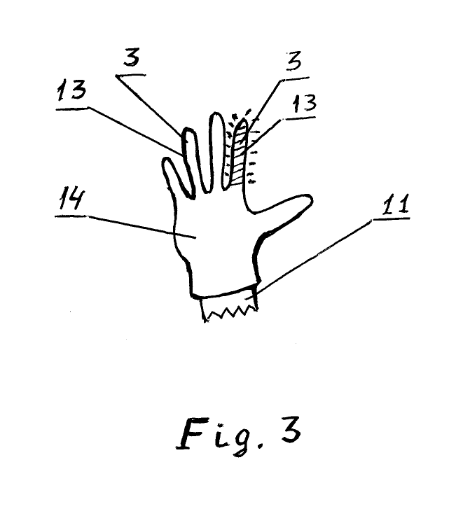

Among other possibilities, the finger-lights 3 can be also placed (fastened) on the gloves (FIG. 3).

In this case every finger cover 13 of the glove 14 can be, among others, covered by an able-to-shine media completely or almost completely. In this case a user see the completely shining/lighting fingers, which are igniting with a light in succession.

Of course, the method can be executed also without the electrical wires 5 “wireless”, i.e. through the control by the electromagnetic fields (the similar way as it takes place also in the known wireless PC-keyboards and wireless mouse-controlled devices). The “wireless” connections of the PC-peripherals belong to the state of technology.

The controlling, among others, the switching-on&-off of the key-lights 2 and finger-lights 3 is executed by a computer (PC) 1 or by its construction elements and software.

The musical compositions (in the acoustic or graphical (as music notes) form) are transformed (over-coded) first in the succession of electrical signals. Wherein the each of a.m. signals corresponds to one music note. Each of these signals can control the key-lights and finger-lights, among others, to switch them on and off, as it described above. The musical compositions in this form (i.e. in an electronic form, wherein the software generates the a.m. succession of the electric control signals, which control signals among others switch-on&-off the key-lights and finger-lights during the playing of this musical composition) are placed in a website (i.e. in the equipment, which generates the a.m. website). The final clients (users), each of them separately, connect their PCs to this website and execute a download of this musical composition in this form into their PCs. Wherein the a.m. musical composition can be, among others, saved in the PC of a final client (user), or this a.m. musical composition can be transmitted in a RAM (random-access memory) or in an other memory-device only temporary.

The a.m. signals execute the following operations:

a) First, the signals switch on the key-lights, which correspond to the definite notes, and simultaneously these signals indicate by a shining light the definite fingers, by which one have to press these keys.

Then b) after this key was already pressed, these signals switch off the both shining/lighting indicators (under the key and on the finger).

And c) these signals send a command to the user's PC&its peripherals to generate an acoustic signal (sound), which corresponds to this a.m. note.

Wherein, a final client (user) connects the a.m. musical keyboard, equipped with the a.m. key-lights and finger-lights, to his PC, when the connection of the user's PC with the a.m. website is executed, and the musical composition is ordered from this website.

Or, a final client (user) can use the a.m. musical keyboard directly to connect to Internet, because an usual VC keyboard comprises more keys, then a musical keyboard of an electronic piano. Therefore one can use the remaining keys for another aims, among others for the operations in Internet (here is meant, that if instead of an usual PC keyboard one connects to a PC a musical keyboard, where the piano keys are topologically placed instead of the PC-keyboard buttons, one can add to this musical keyboard some more keys even without changing of an electric connection schema, because the quantity of keys in the a.m. musical keyboard is less then in the a.m. PC-keyboard).

Or, a final client (user) can hold the both musical and PC-keyboards in the mechanically connected to PC state, and to change keyboards electronically by switching over from one keyboard to another.

Or, the both keyboards can work together.

Or, one can provide a standard PC keyboard with the key-lights, and therewith one can also play music the a.m. way also with this keyboard.

Instead of an usual PC one can use a mobile telephone, among others an internet-capable mobile telephone, which is provided with a connecting plug-in for an external keyboard, as well with the corresponding hardware and software.

The mobile telephone either executes a download of the software and hardware, which are necessary for the above described playing of music, and then supports the above described switching-on&-off of the key-lights and finger-lights “off-line”, or this mobile telephone execute the control of these a.m. key-lights and finger-lights “on-line”, in the direct connection with the corresponding website.

In the Claims under the terms “computer” or “PC” one understands also laptop, I-Pad, I-Pod, I-Phone, mobile telephone, or PDA, or also any other stationary o mobile electronic device, which can execute the computer functions.

What is claimed is:

1. A method/process for playing of musical melodies, wherein the placed under (or on-, or in-, or near-) the keys (buttons) of a musical instrument shining/lighting indicators (subsequently referred to in this description as “key-lights”), are switched on in succession, and correspondently these keys are pressed in succession, after their light-ignition, by the fingers, wherein the shining/lighting indicators are placed also on the fingers.

2. A method according to claim 1, in which the key-lights of claim 1, and the placed on the fingers shining/lighting indicators of claim 1 (subsequently referred to in this description as “finger-lights”) are connected to a switching-on&switching-off device, wherein either
a key-light of a key and a finger-light of a finger are switched-on by this device simultaneously, wherein the a.m. key is the exactly that key, which must be pressed in one determinate definite moment of time for the playing of a musical note, and wherein the a.m. finger is the exactly that finger, by which this key must be pressed in this determinate definite moment of time for the playing of this musical note, or
two or more key-lights of keys and also two or more finger-lights of fingers are switched-on by this device simultaneously, wherein the a.m. keys are the exactly those keys, which must be pressed simultaneously in one determinate definite moment of time for the simultaneous playing of two or more musical notes, and wherein the a.m. fingers are the exactly those fingers, by which these keys must be pressed in this determinate definite moment of time for the playing of these musical notes.

3. A method according to claim 2, in which the before switched-on key-lights and finger-lights are than switched of simultaneously, after a lighting/shining in the moment key or a nearby located key is pressed.

4. A method according to claim 3, in which the control of the process, among others the switching-on&switching-off of the key-lights and finger-lights, is executed by a computer (PC) or by its construction elements and software.

5. A method according to claim 4, in which
first a musical composition (or many musical compositions) is transformed (overcoded) into an algorithm of the in succession executed switchings-on&switchings-off of the key-lights, or finger-lights, or both, where the every switching-on corresponds to one note sign of the musical notation;
after that this musical notation in this form is either placed in a website, or it is written in an electronic data carrier, among others on a disk drive (as for example CD,DVD or others) for a further distribution;
after that the final clients (users), each of them separately, connect their computers (PCs) to this a.m. website, or to one of the a.m. data carriers;
and after that the a.m. musical notation in the a.m. form, or the necessary software or both, are downloaded in the computers of the a.m. users, or in the RAM (random-access memory) of the computers of the a.m. users, or in a peripheral device, wherein the key-lights and finger-lights are switched-on/off and controlled by the a.m. computer (or by its peripheral device), or this switching-on/off of these shining/lighting indicators and controlling of these shining/lighting indicators is executed directly from the a.m. website or from the a.m. data carrier.

6. A method according to claim 5, in which instead of the keys of a keyboard one places the key-lights under- (or on- or near-) the strings of a stringed instrument or of a stringed-bow instrument, wherein also one touch the a.m. strings instead of pressing the keys to play music.

7. Device for playing of musical melodies and for learning to play musical melodies, which (device) comprises
the shining/lighting indicators, which are placed under-, on-, in-, or near the keys of an electronic piano (keyboard),
system for switching-on and switching-off of these shining/lighting indicators,
means for controlling of this a.m. switching-on&off system,
wherein the a.m. device comprises also
the shining/lighting indicators for placing on the human fingers, which indicators are provided with the means for their fastening on the human fingers (as, among others, Velcro-fastening, or round rubber-rings fastenings, or others, in particular these indicators can be located on the gloves, to put them on human hands, etc.), wherein these shining/lighting indicators are electrically connected to the system for switching-on&off of these shining/lighting indicators, and thereby are these shining/lighting indicators also connected with the means for controlling of this a.m. switching-on&off system.

8. A device according to claim 7,
wherein the a.m. device comprises a PC, wherein the a.m. electronic piano-keyboard is connected to this PC, wherein the above mentioned system for switching-on and switching-off of these shining/lighting indicators and the means for controlling of this a.m. switching-on&off system are the components (parts) of this PC, which are belong to hardware and software of this PC; and therewith the a.m. electronic piano-keyboard does not comprise the a.m. switching-on&-off system and the a.m. controlling means.

9. A device according to claim 8,
in which also all further necessary for the playing of music means (except the keys, key-lights and finger-lights), namely, among others, display, microchip and control means, signal amplifier, loudspeaker, or the like, are the components (parts) of a PC and its peripherals; and therewith the piano-keyboard of claim 8 does not comprise also the a.m. means.

10. A device according to claim 9, in which the piano-keyboard of claim 9 has the such electrical circuit of the keys connection, which circuit is identical to a standard circuit of the keys connection of a typical PC keyboard, wherein the geometrical form and topological placing of keys remains the same as in a musical piano keyboard and typical for a musical piano keyboard, and wherein the keys are provided with the shining/lighting indicators.

11. A device according to claim 10, in which the piano-keyboard of claim 10 is completely identical to an usual standard PC keyboard, excepting that the keys are provided with the a.m. key-lights.

12. A device for playing of musical melodies and for learning to play musical melodies by means of stringed instruments (among others guitar), or by means of stringed-bow instruments (among others violin), which device comprises strings, a fingerboard and a sounding board (or an electrical or electronic transducer of the strings vibrations into the acoustic signals), wherein the a.m. device also comprises the shining/lighting indicators, which indicators are placed under (or on-, or near-) the strings in the areas, where these strings have to be touched by human fingers or by other means (as for example violin bow, guitar mediator, claws,, or others), wherein, among others, these areas are located in the fingerboard-part and in the sounding board-part of the instrument, or in the region of the mentioned above in this claim transducer.

13. A device according to claim 12 in which the device comprises the finger-lights.

14. A device according to claim 13, in which the device comprises a PC, wherein the system for switching-on and switching-off of the shining/lighting indicators and the means for controlling of this a.m. switching-on&off system are the components (parts) of this PC, which are belong to hardware and software of this PC.

15. A device according to claim 8, which device does not comprise the finger-lights.

16. A device according to claim 9, which device does not comprise the finger-lights.

17. A device according to claim 10, which device does not comprise the finger-lights.

18. A device according to claim 11, which device does not comprise the finger-lights.
